(19) United States
(12) Patent Application Publication
(10) Pub. No.: US 2024/0027722 A1
(43) Pub. Date: Jan. 25, 2024

(54) FLAT-SURFACED TUNABLE OPTICAL LENS

(71) Applicant: Meta Platforms Technologies, LLC, Menlo Park, CA (US)

(72) Inventors: Dongmin YANG, San Jose, CA (US); Fei Liu, Los Altos, CA (US)

(73) Assignee: Meta Platforms Technologies, LLC, Menlo Park, CA (US)

(21) Appl. No.: 18/093,715

(22) Filed: Jan. 5, 2023

Related U.S. Application Data
(60) Provisional application No. 63/391,506, filed on Jul. 22, 2022.

(51) Int. Cl. G02B 7/02; G02B 27/01

(52) U.S. Cl. CPC G02B 7/023; G02B 27/0172; G02B 2027/0178

(57) ABSTRACT

A flat-surfaced, electrically controlled, tunable lens to provide autofocus, optical zoom, optical image stabilization, and similar functionalities is described. A thickness profile of the tunable lens may be modified through a voltage-controlled thin film piezo actuator, for example, a lead-zirconium-titanium oxide (PZT) film. For autofocus and optical zoom features, an entire thickness of the tunable lens may be modified with the thickness being the same across a cross-section area of the tunable lens and opposing surfaces of the tunable lens remaining flat. For optical image stabilization, the thickness profile of the tunable lens may be modified to a tilted profile, where one side of the tunable lens is thinner than the other side with the opposing surfaces of the tunable lens remaining flat. The tilted profile may have an angle between the two plates (surfaces) in a range up to 10 degrees.

### CROSS REFERENCE TO RELATED APPLICATIONS

This patent application claims the benefit of U.S. Provisional Patent Application Ser. No. 63/391,506 filed on Jul. 22, 2022. The disclosures of the above application are hereby incorporated by reference for all purposes.

### TECHNICAL FIELD

This patent application relates generally to optical lenses, and specifically, to a flat-surfaced, electrically controlled, tunable optical lens with a thickness profile modifiable through one or more piezo actuators to change an optical beam's path through the optical lens.

### BACKGROUND

With the advance of optical and electronic technology fields, camera sizes are progressively decreasing while camera functionalities and capabilities are expanding. Miniaturized cameras may be found in wearable devices such as smart phones, smart watches, and smart glasses that may incorporate augmented reality (AR) and/or virtual reality (VR) functionality.

For some camera features, such as autofocus, optical zoom, and/or optical image stabilization, wearable device camera characteristics such as small footprint, low power consumption, fast response time, and/or avoidance of moving parts may present a challenge in providing these features with the characteristic limitations imposed on the wearable device cameras.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a perspective view of a near-eye display in form of a pair of augmented reality (AR) glasses, according to an example.

FIG. 1B illustrates a top view of a near-eye display in form of a pair of augmented reality (AR) glasses, according to an example.

FIG. 2A illustrates a side cross-sectional view of a flat surfaced, tunable optical lens in two different profile states, according to an example.

FIG. 2B illustrates a close-up side cross-sectional view of a flat surfaced, tunable optical lens with details of the piezo actuator, according to an example.

FIG. 2C illustrates a configuration of electrically controlling a flat surfaced, tunable optical lens thickness to achieve focus shift for autofocus, according to an example.

FIG. 3A illustrates a side cross-sectional view of a flat surfaced, tunable optical lens in two different profile states, according to an example.

FIGS. 3B and 3C illustrate side cross-sectional views of optical zoom configurations with and without flat surfaced, tunable optical lens(es), according to an example.

FIG. 4A illustrates a side cross-sectional view of a flat surfaced, tunable optical lens in two different profile states, according to an example.

FIG. 4B illustrates a configuration of electrically controlling a flat surfaced, tunable optical lens thickness to modify camera viewing direction to achieve optical image stabilization, according to an example.

FIG. 5 illustrates a flow diagram of a method for modifying a profile state of a flat surfaced, tunable optical lens to perform an optical operation, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As used herein, a “near-eye display” may refer to any display device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein, a “user” may refer to a user or wearer of a “near-eye display.” A “wearable device” may refer to any portable electronic device that may be worn by a user and include a camera and/or a display to capture and/or present content to a user. Examples of “wearable devices” may include, but are not limited to, smart watches, smart phones, headsets, and near-eye display devices.

Cameras in wearable devices are subject to design requirements such as small form factor, low power consumption, fast response time, and mechanical reliability. Due to the wearable nature of the containing devices, small size (lighter weight) is an important design consideration. In wearable devices, available power is another design constraint. Furthermore, moving parts such as mechanically adjustable lenses, etc. may increase a failure risk in wearable devices due to higher likelihood of drops, hits, etc. Thus, camera features such as autofocus, optical zoom, and optical image stabilization may be desired, but add to power consumption, size, and reliability risks.

In some examples of the present disclosure, a flat-surfaced, electrically controlled, tunable lens may be used to provide autofocus, optical zoom, optical image stabilization, and similar functionalities. A thickness profile of the tunable lens may be modified through a voltage-controlled thin film piezo actuator, for example, a lead-zirconium-titanium oxide (PZT) film. For autofocus and optical zoom features, an entire thickness of the tunable lens may be modified with the thickness being the same across a cross-section area of the tunable lens and opposing surfaces of the tunable lens remaining flat. For optical image stabilization, the thickness profile of the tunable lens may be modified to a tilted profile, where one side of the tunable lens is thinner than the other side with the opposing surfaces of the tunable lens remaining flat. The tilted profile may, in some examples, have an angle between the two plates (surfaces) in a range up to 10 degrees.

In some examples, the tunable lens may be made using a polymer or similar deformable, but not liquid, material. Two flat plates, such as glass or plastic, may be used to maintain a flatness of the opposing surfaces of the tunable lens. The flat plates may be transparent plates. Alternatively, the plates may also be used for additional functionality such as polarization, phase modification, optical filtering, and comparable ones.

While some advantages and benefits of the present disclosure are apparent, other advantages and benefits may include low power consumption by use of the thin film piezo actuators, smaller size of the tunable lens, decrease of optical assembly size by reduction of gaps between assembly components, increase of reliability by avoidance of mechanically movable parts, and/or immunity to electromagnetic interference by avoiding complex circuitry to control various features.

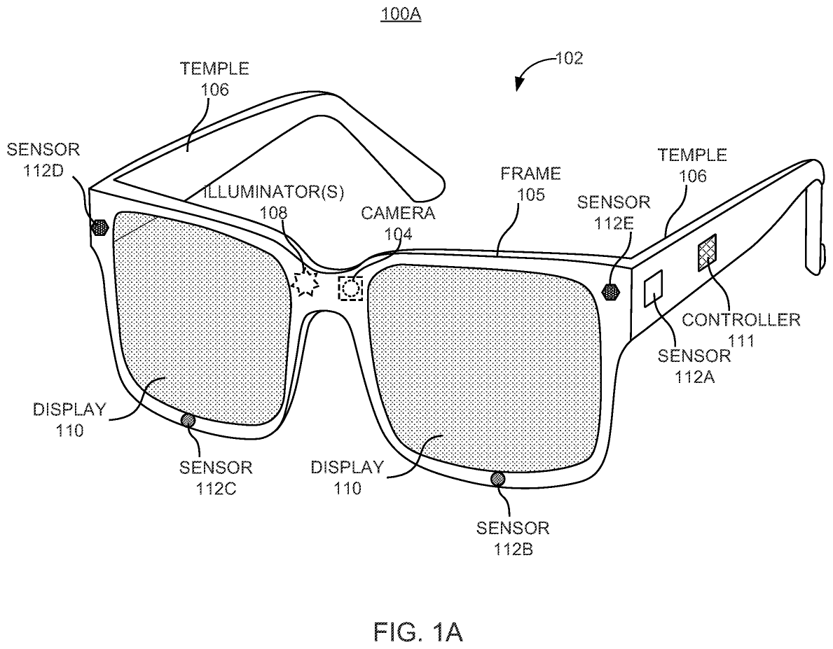

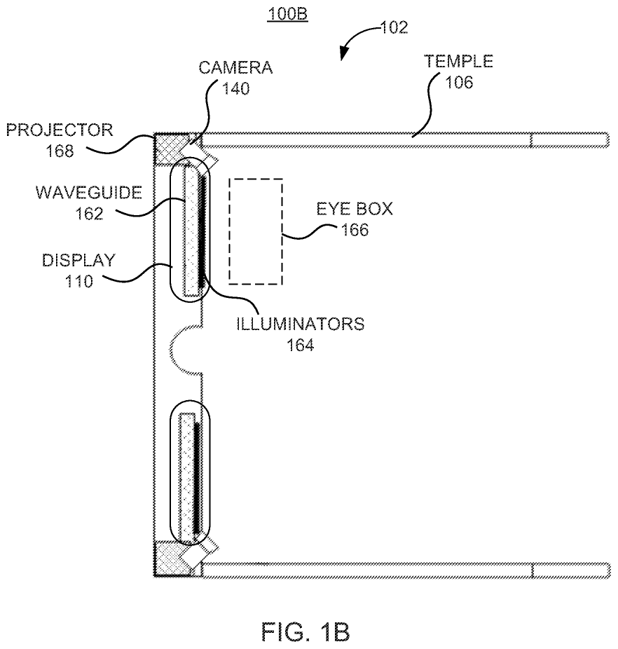

FIG. 1A is a perspective view of a near-eye display 102 in the form of a pair of glasses (or other similar eyewear), according to an example. In some examples, the near-eye display 102 may be configured to operate as a virtual reality display, an augmented reality (AR) display, and/or a mixed reality (MR) display.

As shown in diagram 100A, the near-eye display 102 may include a frame 105 and a display 110. In some examples, the display 110 may be configured to present media or other content to a user. In some examples, the display 110 may include display electronics and/or display optics. For example, the display 110 may include a liquid crystal display (LCD) display panel, a light-emitting diode (LED) display panel, or an optical display panel (e.g., a waveguide display assembly). In some examples, the display 110 may also include any number of optical components, such as waveguides, gratings, lenses, mirrors, etc. In other examples, the display 110 may include a projector, or in place of the display 110 the near-eye display 102 may include a projector. The projector may use laser light to form an image in angular domain on an eye box for direct observation by a viewer's eye, and may include a vertical cavity surface emitting laser (VCSEL) emitting light at an off-normal angle integrated with a photonic integrated circuit (PIC) for high efficiency and reduced power consumption.

In some examples, the near-eye display 102 may further include various sensors 112A, 112B, 112C, 112D, and 112E on or within a frame 105. In some examples, the various sensors 112A-112E may include any number of depth sensors, motion sensors, position sensors, inertial sensors, and/or ambient light sensors, as shown. In some examples, the various sensors 112A-112E may include any number of image sensors configured to generate image data representing different fields of views in one or more different directions. In some examples, the various sensors 112A-112E may be used as input devices to control or influence the displayed content of the near-eye display, and/or to provide an interactive virtual reality (VR), augmented reality (AR), and/or mixed reality (MR) experience to a user of the near-eye display 102. In some examples, the various sensors 112A-112E may also be used for stereoscopic imaging or other similar application.

In some examples, the near-eye display 102 may further include one or more illuminators 108 to project light into a physical environment. The projected light may be associated with different frequency bands (e.g., visible light, infra-red light, ultra-violet light, etc.), and may serve various purposes. In some examples, the one or more illuminator(s) 108 may be used as locators.

In some examples, the near-eye display 102 may also include a camera 104 or other image capture device. The camera 104, for instance, may capture images of the physical environment in the field of view. In some instances, the captured images may be processed, for example, by a virtual reality engine to add virtual objects to the captured images or modify physical objects in the captured images, and the processed images may be displayed to the user by the display 110 for augmented reality (AR) and/or mixed reality (MR) applications.

In some examples, the camera 104 may include autofocus feature enabled by an optical lens and a tunable optical lens assembly, which may include a tunable optical lens sandwiched between two plates. Two thin film piezo actuators positioned on end portions of one of the plates may push the plates together and change a thickness of the tunable optical lens while keeping the opposite surfaces receiving and emitting light substantially flat. By changing the thickness of the tunable optical lens assembly, the camera may adjust its focus in response to changing scenery. In other examples, the camera may include an optical zoom feature, where one or more tunable optical lens assemblies may be placed between optical lens assemblies for different zoom levels shortening gaps between the optical lens assemblies and reducing an overall size of the optical lens portion of the camera 104. In further examples, the camera 104 may include an optical image stabilization feature, where a thickness profile of the tunable optical lens assembly may be modified to a tilted type profile to change a direction of incident light beam (e.g., when the camera is tilted, an object of interest is moving about, or the camera is moving or shaking when its carrier is in movement).

In some examples, change of the thickness profile of the tunable optical lens assembly may be managed by controller 111. For example, the controller 111 may receive sensor information associated with autofocus, optical zoom, or optical image stabilization, and cause a thickness profile change of the tunable optical lens assembly by controlling a voltage applied to the thin film piezo actuator(s). In some examples, management of the camera features associated with the tunable optical lens assembly may be performed entirely or partially by the controller 111. In other examples, a remote controller communicatively coupled to the near-eye display device 102 may perform some or all of the functions.

FIG. 1B is a top view of a near-eye display 102 in the form of a pair of glasses (or other similar eyewear), according to an example. As shown in diagram 100B, the near-eye display 102 may include a frame 105 having a form factor of a pair of eyeglasses. The frame 105 supports, for each eye: a scanning projector 168 such as any scanning projector variant considered herein, a pupil-replicating waveguide 162 optically coupled to the projector 168, an eye-tracking camera 140, and a plurality of illuminators 164. The illuminators 164 may be supported by the pupil-replicating waveguide 162 for illuminating an eye box 166. The projector 168 may provide a fan of light beams carrying an image in angular domain to be projected into a user's eye.

In some examples, multi-emitter laser sources may be used in the projector 168. Each emitter of the multi-emitter laser chip may be configured to emit image light at an emission wavelength of a same color channel. The emission wavelengths of different emitters of the same multi-emitter laser chip may occupy a spectral band having the spectral width of the laser source. The projector 168 may include, for example, two or more multi-emitter laser chips emitting light at wavelengths of a same color channel or different color channels. For augmented reality (AR) applications, the pupil-replicating waveguide 162 may be transparent or translucent to enable the user to view the outside world together with the images projected into each eye and superimposed with the outside world view. The images projected into each eye may include objects disposed with a simulated parallax, so as to appear immersed into the real-world view.

The eye-tracking camera 140 may be used to determine position and/or orientation of both eyes of the user. Once the position and orientation of the user's eyes are known, a gaze convergence distance and direction may be determined. The imagery displayed by the projector 168 may be adjusted dynamically to account for the user's gaze, for a better fidelity of immersion of the user into the displayed augmented reality scenery, and/or to provide specific functions of interaction with the augmented reality. In operation, the illuminators 164 may illuminate the eyes at the corresponding eye boxes 166, to enable the eye-tracking cameras to obtain the images of the eyes, as well as to provide reference reflections. The reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes 166.

In some examples, the camera 140 may include autofocus feature enabled by an optical lens and a tunable optical lens assembly, which may include a tunable optical lens sandwiched between two plates. Two thin film piezo actuators positioned on end portions of one of the plates may push the plates together and change a thickness of the tunable optical lens while keeping the opposite surfaces receiving and emitting light substantially flat. By changing the thickness of the tunable optical lens assembly, the camera may adjust its focus in response to changing scenery. In other examples, the camera 140 may include an optical zoom feature, where one or more tunable optical lens assemblies may be placed between optical lens assemblies for different zoom levels shortening gaps between the optical lens assemblies and reducing an overall size of the optical lens portion of the camera 140. In further examples, the camera 140 may include an optical image stabilization feature, where a thickness profile of the tunable optical lens assembly may be modified to a tilted type profile to change a direction of incident light beam (e.g., when the camera is tilted, or an object of interest is moving about).

Some implementations of autofocus, optical zoom, and optical image stabilization may employ miniature motors (to move the lenses), liquid optical lenses, and similar ones. Mechanical techniques such as motors may increase size of the camera and negatively impact a reliability of the device due to moving parts. Liquid lenses may be difficult to control their shape, which may result in stray lights, aberrations, etc. Furthermore, both approaches may be associated with higher power consumption and may be susceptible to electromagnetic interference because complex circuitry may be needed to control the mitigation apparatus. Liquid lenses may also degrade image quality due to difficulty in controlling their surface shape.

Functions described herein may be distributed among components of the near-eye display 102 in a different manner than is described here. Furthermore, a near-eye display as discussed herein may be implemented with additional or fewer components than shown in FIGS. 1A and 1B. While the near-eye display 102 is shown and described in form of glasses, a flat-surfaced, electrically controlled, tunable lens may be implemented in other forms of near-eye displays such as goggles or headsets, as well as in non-wearable devices such as smart watches, smart phones, and similar ones.

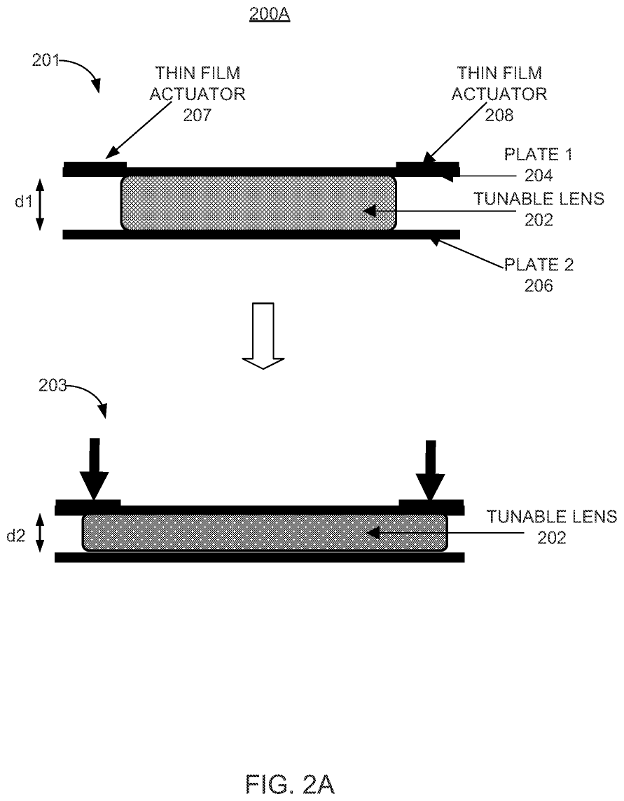

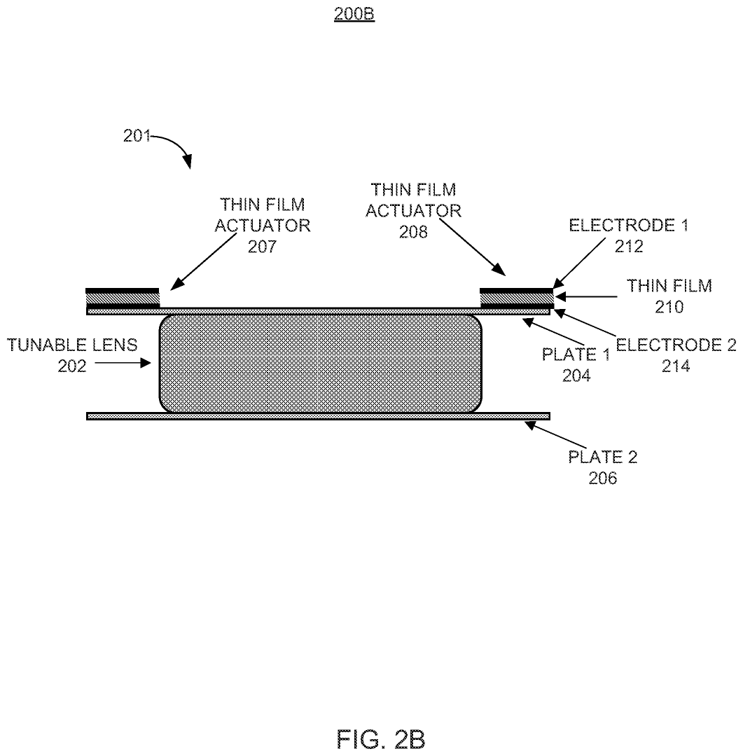

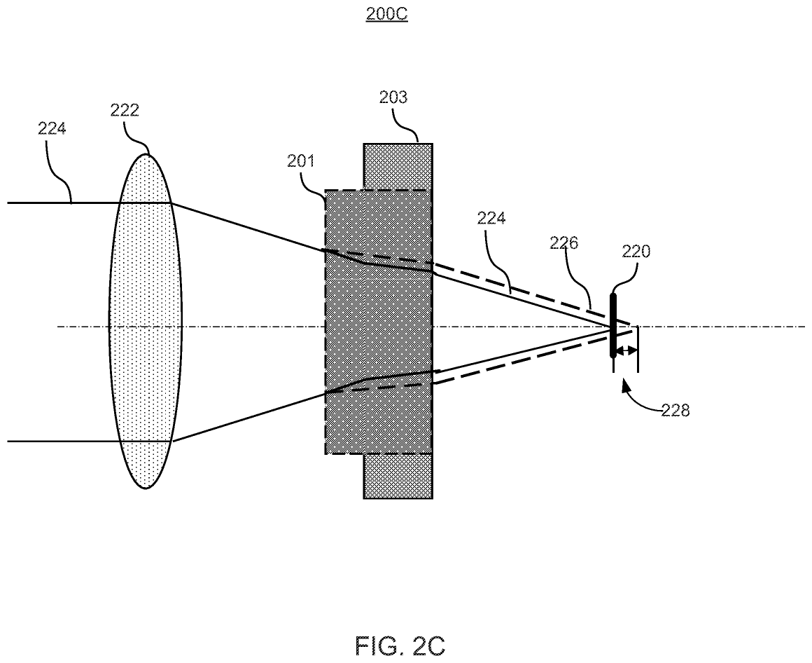

FIG. 2A illustrates a side cross-sectional view of a flat surfaced, tunable optical lens in two different profile states, according to an example. Diagram 200A shows a tunable optical lens assembly 201, which includes a tunable optical lens 202 sandwiched between a first plate 204 and a second plate 206. Thin film piezo actuators 207 and 208 may be positioned on a top surface of the first plate 204 at opposite end portions of the first plate 204. The tunable optical lens 202 may have a thickness of d1. Following activation of the thin film piezo actuators 207, 208, the first plate 204 may be pushed down pressing the tunable optical lens 202 to a thickness of d2 in tunable optical lens assembly 203.

In some examples, the tunable optical lens 202 may be made from soft or semi-soft material that can be reshaped by the movement of one or more of the first plate 204 or the second plate 206 and return to its original shape when one or both of the plates are moved back to their original position(s). Example material may include a polymer, a silicon compound, or comparable ones. In other examples, the tunable optical lens 202 may also be a liquid lens. The first plate 204 and the second plate 206 may provide surface stability ensuring ingress and exit surfaces of the tunable optical lens assembly 201 are constantly flat. A refractive index of the tunable optical lens material may be selected based on an application and camera configuration.

In some examples, the thin film piezo actuators 207 and 208 may be positioned on opposite end portions of the first plate 204 as shown in diagram 200A. As the tunable optical lens assembly 201 includes a width (as well as length), the thin film piezo actuators 207 and 208 may cover a substantial portion of the assembly's width to provide even force application. Alternatively, four thin film piezo actuators, instead of two, may be used, one at each corner of the tunable optical lens assembly 201. In other examples, the thin film piezo actuators 207 and 208 may instead be placed on corresponding end portions of the second plate 206. Yet, in further examples, thin film piezo actuators may be placed on both plates. For example, to control a thickness profile of a larger tunable optical lens, two sets of thin film piezo actuators may be more practical. The thin film piezo actuators 207 and 208 may provide the advantage of consuming low power. Indeed, the actuators may consume power only when activated with no power consumption in rest states (pressed or unpressed). Compared to alternative approached such as motors, activation power consumption of thin film piezo actuators may also be relatively low. Furthermore, the tunable optical lens assembly 201 (or 203) may have a smaller footprint and thickness compared to alternative approaches.

In some examples, the first plate 204 and/or the second plate 206 may be a transparent glass plate, a transparent plastic plate, or similar. One or both plates may also be used for additional optical functionality and include other optical elements such as a filter, a polarizer, a phase plate, a quarter wave plate, and/or comparable ones.

FIG. 2B illustrates a close-up side cross-sectional view of a flat surfaced, tunable optical lens with details of the piezo actuator, according to an example. Diagram 200B shows tunable optical lens assembly 201 with the tunable optical lens 202, the first plate 204, and the second plate 206. The thin film piezo actuators 207 and 208 may be implemented, in one example, with a thin film 210 sandwiched between a first electrode 212 and a second electrode 214. Depending on a material, a thickness, and/or a footprint of the thin film 210, an appropriate control voltage may be applied through the first electrode 212 and the second electrode 214 to the thin film 210 causing the thin film to expand and push the first plate 204 down, thereby, pressing the tunable optical lens 202.

In some examples, a rectangular thickness profile may be desired to avoid challenges associated with controlling a path of a light beam passing through the optical elements of the camera. Thus, both thin film piezo actuators 207 and 208 may be made from similar material and in similar size, and the thin film piezo actuators 207 and 208 may be activated for the same period causing the thickness change to be the same at both ends of the tunable optical lens 202; hence, the rectangular thickness profile.

In some implementations, lead-zirconium-titanium oxide (PZT) thin film may be used for the thin film piezo actuator(s), although examples are not limited to lead-zirconium-titanium oxide (PZT) thin film. Other example materials may include various metals, ceramics, and/or carbon-based compounds.

FIG. 2C illustrates a configuration of electrically controlling a flat surfaced, tunable optical lens thickness to achieve focus shift for autofocus, according to an example. Diagram 2000 shows a light beam 224 being focused by an optical lens 222. Also shown are tunable optical lens assembly 201 and 203 representing two different thickness profiles. As shown in the diagram 2000, in an original thickness profile of the tunable optical lens assembly 201, the close distance object focused light beam 226 may fall long of an image sensor 220 (i.e., out of focus). With the thinner tunable optical lens assembly 203, however, the light beam 226 may be shifted (228) to light beam 224 and focus on the image sensor 220 providing autofocus for the camera.

Without the tunable optical lens assembly 201, 203, the optical lens 222 or the image sensor 220 may have to be moved to mitigate the focus shift and avoid blurry images (autofocus). In some examples, the original thickness profile of the tunable optical lens assembly 201 may also result in an out-of-focus image as shown in the diagram. Upon sensing the out-of-focus image (either through image processing or through an infrared sensor), a controller of the camera may activate the thin film piezo actuators of the tunable optical lens assembly changing the thickness profile and causing the focus shift 228, which, in turn, may result in the light beam 226 being focused on the image sensor 220 and an in-focus image.

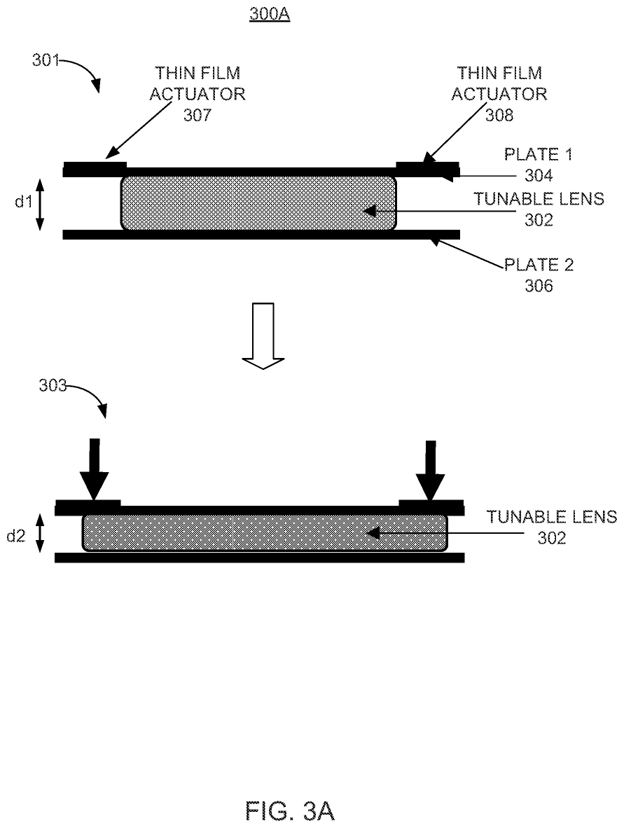

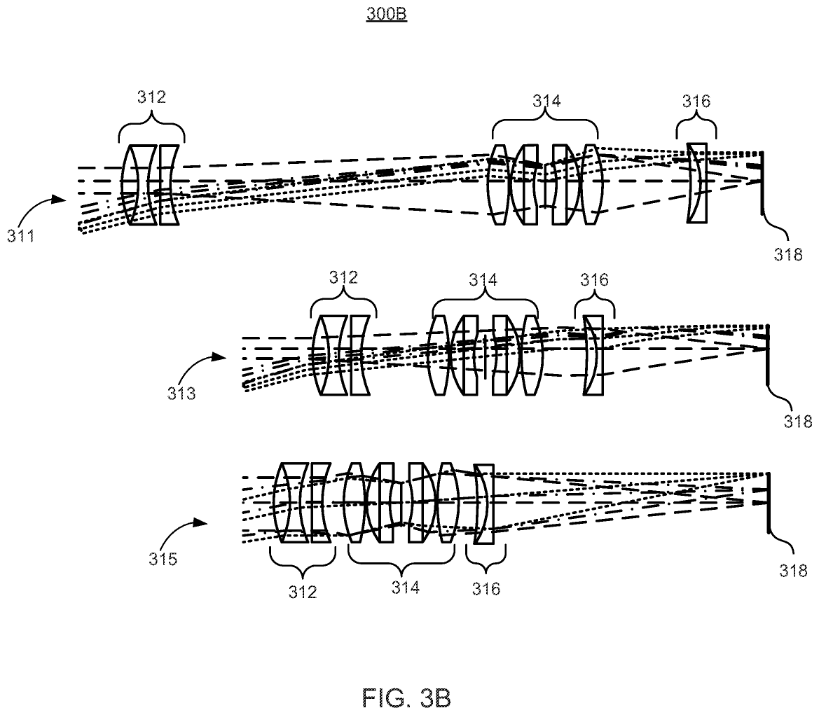

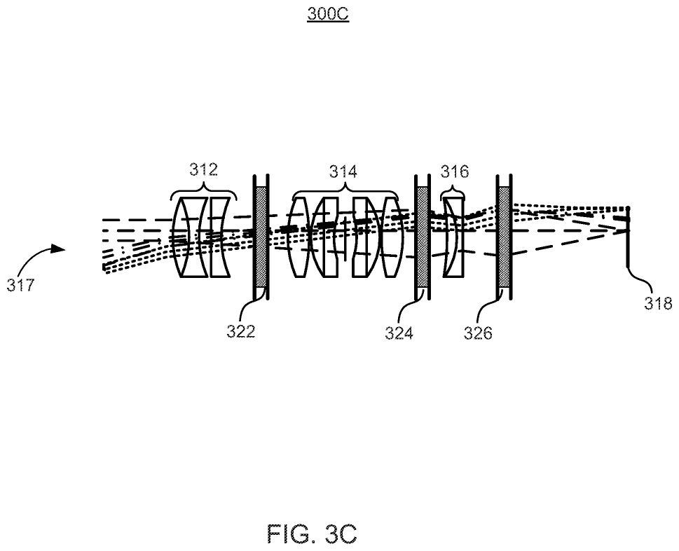

FIG. 3A illustrates a side cross-sectional view of a flat surfaced, tunable optical lens in two different profile states, according to an example. Diagram 300A shows a tunable optical lens assembly 301, which includes a tunable optical lens 302 sandwiched between a first plate 304 and a second plate 306. Thin film piezo actuators 307 and 308 may be positioned on a top surface of the first plate 304 at opposite end portions of the first plate 304. The tunable optical lens 302 may have a thickness of d1. Following activation of the thin film piezo actuators 307, 308, the first plate 304 may be pushed down pressing the tunable optical lens 302 to a thickness of d2 in tunable optical lens assembly 303.

In some examples, the tunable optical lens 302 may be made from soft or semi-soft material that can be reshaped by the movement of one or more of the first plate 304 or the second plate 306 and return to its original shape when one or both plates are moved back to their original position(s). Example material may include a polymer, a silicon compound, or comparable ones. In other examples, the tunable optical lens 302 may also be a liquid lens. The first plate 304 and the second plate 306 may provide surface stability ensuring ingress and exit surfaces of the tunable optical lens assembly 301 are constantly flat. A refractive index of the tunable optical lens material may be selected based on an application and camera configuration, but in practical implementations, a low refractive index may be preferred to avoid refraction control challenges and to provide a predictable path for the passing light beams.

In some examples, the thin film piezo actuators 307 and 308 may be positioned on opposite end portions of the first plate 304 as shown in diagram 300A. In other examples, the thin film piezo actuators 307 and 308 may instead be placed on corresponding end portions of the second plate 306. Yet, in further examples, thin film piezo actuators may be placed on both plates. For example, to control a thickness profile of a larger tunable optical lens, two sets of thin film piezo actuators may be more practical. The thin film piezo actuators 307 and 308 may provide the advantage of consuming low power. Indeed, the actuators may consume power only when activated with no power consumption in rest states (pressed or unpressed). Compared to alternative approached such as motors, activation power consumption of thin film piezo actuators may also be relatively low. Furthermore, the tunable optical lens assembly 301 (or 303) may have a smaller footprint and thickness compared to alternative approaches.

FIGS. 3B and 3C illustrate side cross-sectional views of optical zoom configurations with and without flat surfaced, tunable optical lens(es), according to an example. Diagram 300B in FIG. 3B shows three different zoom configurations of optical lens assemblies of a camera, wide field of view (FOV) 311, medium field of view (FOV) 313, and far-field (tele) field of view (FOV) 315. The optical lens assemblies may include three separate groups: a focusing optical lens assembly 312, a first variator assembly 314, and a second variator and master assembly 316. Light may be focused (and otherwise processed) by the optical lens assemblies and arrive on image sensor 318.

In the wide field of view (FOV) 311, air gap distances between the optical lens assemblies may be biggest to achieve the widest possible field of view (FOV) for the camera. In the far-field (tele) field of view (FOV) 315, the camera may be focusing on distant scenes or objects. Thus, the air gap distances between the optical lens assemblies may be smallest. In the medium field of view (FOV) 313, the air gap distances may be selected between the two extremes. It should be understood that a camera may focus on any distance between the three example field of view (FOV) configurations (or zooms) with air gap distances being adjusted according to a designated focus distance. In conventional cameras, the focusing optical lens assembly 312, the first variator assembly 314, and/or the second variator and master assembly 316 may be moved toward or away from each other mechanically, either manually or by a motorized mechanism. In other examples, the camera may switch between different optical lens assemblies. As with the autofocus feature, optical zoom configurations and techniques may require large size, higher power consumption, and/or be subject to reliability risks due to moving parts.

In some examples, the focusing optical lens assembly 312, the first variator assembly 314, and/or the second variator and master assembly 316 may include groups of various optical lenses such as concave, convex, plano-concave, plano-convex, and similar lenses. The assemblies may also include other optical elements such as a filter, a polarizer, a phase plate, a quarter wave plate, and/or comparable ones.

Diagram 3000 in FIG. 3C shows an optical lens assembly configuration 317, where one or more of tunable optical lens assemblies 322, 324, or 326 may be placed between the focusing optical lens assembly 312, the first variator assembly 314, the second variator and master assembly 316, and the image sensor 318. By having flat (rectangular) profiles, the tunable optical lens assemblies 322, 324, or 326 may add to the optical path between the focusing optical lens assembly 312, the first variator assembly 314, the second variator and master assembly 316, and the image sensor 318 without changing a direction of the light beams. Thus, an overall axial distance between the focusing optical lens assembly 312 and the image sensor 318 may be shorter than an overall distance with air gaps only.

In some examples, a thickness of selected ones of the tunable optical lens assemblies 322, 324, or 326 may be increased adding even more optical path, and thereby, adjusting the zoom of the camera to one of the wide field of view (FOV) 301, the medium field of view (FOV) 313, the far-field (tele) field of view (FOV) 315, or any zoom level between the three. By using electrically controlled tunable optical lens assemblies, effectively same optical zoom levels may be achieved as mechanically moving lens groups to different positions to achieve optical zoom.

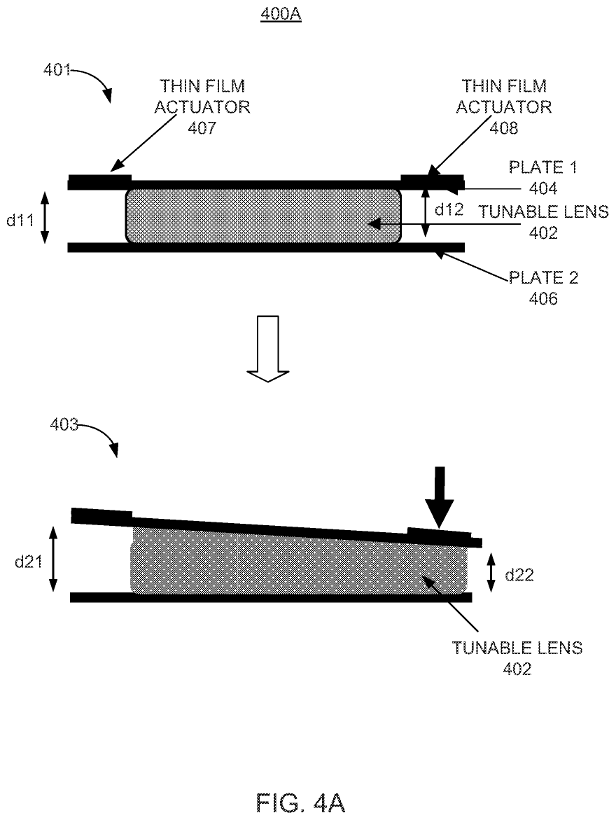

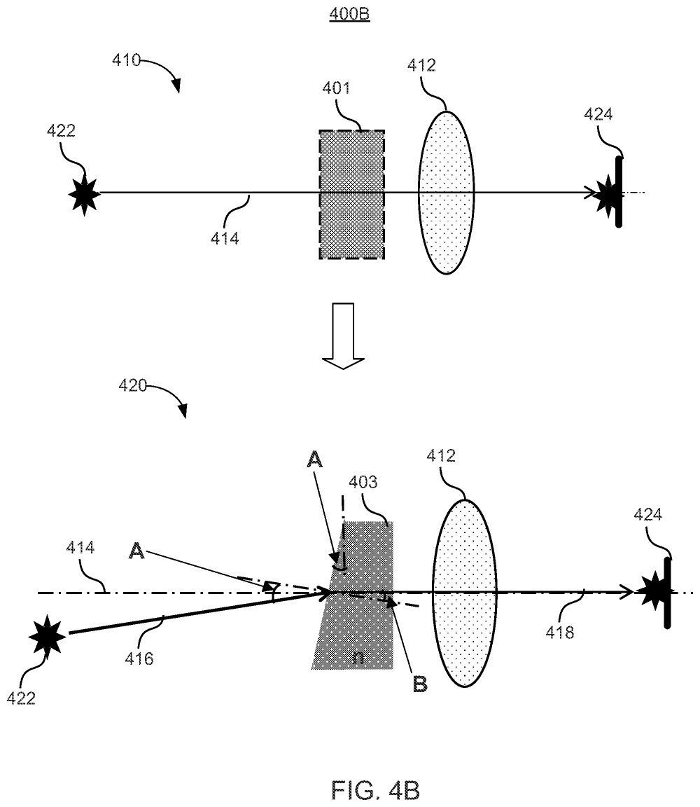

FIG. 4A illustrates a side cross-sectional view of a flat surfaced, tunable optical lens in two different profile states, according to an example. Diagram 400A shows a tunable optical lens assembly 401, which includes a tunable optical lens 402 sandwiched between a first plate 404 and a second plate 406. Thin film piezo actuators 407 and 408 may be positioned on a top surface of the first plate 404 at opposite end portions of the first plate 404. The tunable optical lens 402 may have a thickness of d11 at one end and d12 at the other end. In an original rest state, d11 and d12 may be the same, thus the tunable optical lens 402 may be a flat optical lens. Differently from previous examples, following activation of the thin film piezo actuators 407 and 408, the first plate 404 may be pushed down at an angle pressing one end of the tunable optical lens 402 more than the opposite end with thicknesses d21 and d22, where d21 and d22 are different. Thus, the new thickness profile of the tunable optical lens assembly 403 may be a tilted type profile as opposed to a rectangular profile.

As in the previously discussed examples, the tunable optical lens 402 may be made from soft or semi-soft material that can be reshaped by the movement of one or more of the first plate 404 or the second plate 406 and return to its original shape when one or both of the plates are moved back to their original position(s). Example material may include a polymer, a silicon compound, or comparable ones. In other examples, the tunable optical lens 402 may also be a liquid lens. The first plate 404 and the second plate 406 may provide surface stability ensuring ingress and exit surfaces of the tunable optical lens assembly 401 are constantly flat. A refractive index of the tunable optical lens material may be selected based on an application and camera configuration, but in practical implementations, a low refractive index may be preferred to avoid refraction control challenges and to provide a predictable path for the passing light beams.

In some examples, the thin film piezo actuators 407 and 408 may be positioned on opposite end portions of the first plate 404 as shown in diagram 200A. In other examples, the thin film piezo actuators 407 and 408 may instead be placed on corresponding end portions of the second plate 406. Yet, in further examples, thin film piezo actuators may be placed on both plates. In example implementations for optical image stabilization, the thin film piezo actuators 407 and 408 may be activated differently. For example, one actuator may be activated, not the other one, or both may be activated for different periods (push amounts different) to provide a tilted type thickness profile as opposed to a rectangular profile. The tilted profile may, in some examples, have an angle between the two plates (surfaces) in a range up to 10 degrees. In practical implementations, a narrower range up to about 5 degrees may also be used.

FIG. 4B illustrates a configuration of electrically controlling a flat surfaced, tunable optical lens thickness to modify camera viewing direction to achieve optical image stabilization, according to an example. Diagram 400B shows a first scenario 410, where an object 422 whose image is being captured at an image sensor 424 through a tunable optical lens assembly 401 in an original thickness profile and an optical lens 412 with a light beam 414 aligned with an axis between the object 422 and the image sensor 424. In a second scenario 420, the object 422 is moved away from the axis. Thus, the light beam 416 from the object is not aligned with the axis. However, the tunable optical lens assembly 403 has a modified thickness profile with a tilted receiving surface, which allows a direction of the light beam 416 to be changed and aligned with the axis as light beam 418 arriving at the image sensor 424.

As mentioned herein, thin film piezo actuators may be used to modify a thickness profile of the tunable optical assembly to a tilted type profile. In the tilted type profile, the tilted receiving surface may cause an incident light beam to change its direction at an angle B. If the tilt angle of the receiving surface is A, a relationship between the two angles may be described as follows:

1*Sin(A)=n*Sin(B), (1)

where n is a refractive index of the material of the tunable optical lens.

Accordingly, a tilt angle for the receiving surface of the tunable optical lens assembly 403 may be determined based on a detected angle of the object 422 from the orthogonal axis of the image sensor 424 (also referred to as the camera's viewing direction). A controller for the camera may receive input form a sensor (e.g., an infrared sensor) and compute the angle (B) of the object 422, then compute the tilt angle (A) and activate the thin film piezo actuators to adjust the thickness profile of the tunable optical lens assembly 403.

In some examples, the controller may periodically or dynamically (upon detecting a change) monitor and detect changes in the object's position relative to the camera's viewing direction. As the actuator-based modification of the thickness profile may be a rapid process (e.g., compared to a motorized adjustment), optical image stabilization may be provided with fast response time using a tunable optical lens assembly. As in the other camera features discussed herein, lower power consumption, smaller camera size, higher reliability, and less susceptibility to electromagnetic interference may also be achieved using the tunable optical lens assembly.

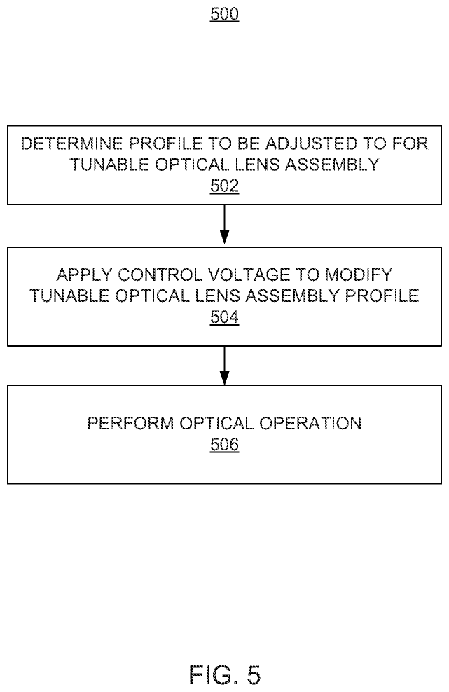

FIG. 5 illustrates a flowchart of a method 500 for modifying a profile state of a flat surfaced, tunable optical lens to perform an optical operation, according to an example. The method 500 is provided by way of example, as there may be a variety of ways to carry out the method described herein. Although the method 500 is primarily described as being performed to implement the examples of FIGS. 2C, 3C, and 4B, the method 500 may be executed or otherwise performed by one or more processing components of another system or a combination of systems to implement other models. Each block shown in FIG. 5 may further represent one or more processes, methods, or subroutines, and one or more of the blocks may include machine readable instructions stored on a non-transitory computer readable medium and executed by a processor or other type of processing circuit to perform one or more operations described herein.

At block 502, a thickness profile to be adjusted to for the tunable optical lens assembly (e.g., tunable optical lens assembly 301) may be determined based on a feature being deployed. For example, for autofocus, a thickness of the tunable optical lens assembly may be increased or decreased with the opposing surfaces of the tunable optical lens 302 remaining parallel to allow a shift of the focus for the camera 104. In another example, the feature may be optical image stabilization, and the thickness profile may need to be adjusted to a tilted type profile with one surface being tilted compared to the other surface to allow an incident light beam to change its direction in alignment with a central axis of the camera.

At block 504, a voltage may be applied to one or both of the thin film piezo actuators 308 by the controller 111. When activated the thin film piezo actuators may push one plate toward the other changing the thickness profile of the tunable optical lens assembly to the determined profile. In some examples, a feedback loop may provide information to the controller about the actual adjusted thickness profile or an image quality at the image sensor such that the controller may iteratively modify the thickness profile for improved implementation of the selected camera feature.

At block 506, an optical operation (e.g., capture of an image or a video) may be performed with the selected camera feature such as autofocus, optical zoom, or optical image stabilization. In response to changing conditions (e.g., changing scenery or object of interest moving), the thickness profile may be modified in a continuous manner based on feedback to the controller.

According to examples, a method of making a flat-surfaced, electrically controlled, tunable lens is described herein. A system of making the flat-surfaced, electrically controlled, tunable lens is also described herein. A non-transitory computer-readable storage medium may have an executable stored thereon, which when executed instructs a processor to perform the methods described herein.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A tunable optical lens assembly, comprising:
a tunable optical lens;
a first plate positioned on a first surface of the tunable optical lens that receives light;
a second plate positioned on a second surface of the tunable optical lens that emits the received light, wherein the first surface and the second surface are flat; and
at least one thin film piezo actuator to adjust a thickness profile of the tunable optical lens assembly.

2. The tunable optical lens assembly of claim 1, wherein at least one of the first plate or the second plate comprises a transparent glass or a transparent plastic.

3. The tunable optical lens assembly of claim 1, wherein at least one of the first plate or the second plate comprises a filter, a polarizer, a phase plate, or a quarter wave plate.

4. The tunable optical lens assembly of claim 1, wherein the tunable optical lens comprises a polymer or a silicon-based compound.

5. The tunable optical lens assembly of claim 1, wherein the at least one thin film piezo actuator comprises a lead-zirconium-titanium oxide (PZT) film actuator.

6. The tunable optical lens assembly of claim 1, further comprising:
two thin film piezo actuators positioned on opposing two end portions of the first plate or the second plate.

7. The tunable optical lens assembly of claim 6, wherein the two thin film piezo actuators are to adjust the thickness profile of the tunable optical lens assembly maintaining a parallel position between the first plate and the second plate of the tunable optical lens assembly.

8. The tunable optical lens assembly of claim 6, wherein the two thin film piezo actuators are to adjust the thickness profile of the tunable optical lens assembly to a tilted profile with a first distance between the first plate and the second plate at a first end portion of the tunable optical lens assembly being different from a second distance between the first plate and the second plate at a second end portion of the tunable optical lens assembly.

9. The tunable optical lens assembly of claim 8, wherein the tilted profile provides for an up to 10 degrees change of direction of the received light.

10. An image capture device, comprising:
a first optical lens assembly; and
a first tunable optical lens assembly to shift a focus point of the first optical lens assembly, the first tunable optical lens assembly comprising:
a tunable optical lens;
a first plate positioned on a first surface of the tunable optical lens that receives light;
a second plate positioned on a second surface of the tunable optical lens that emits the received light, wherein the first surface and the second surface are flat; and
at least one thin film piezo actuator to adjust a thickness profile of the tunable optical lens assembly.

11. The image capture device of claim 10, wherein the first optical lens assembly comprises one or more optical lenses.

12. The image capture device of claim 10, further comprising:
a second optical lens assembly comprising one or more optical lenses; and
a second tunable optical lens assembly positioned between the second optical lens assembly and an image sensor, wherein
the first tunable optical lens assembly and the second tunable optical lens assembly modify a length of an optical path for optical zoom produced by the first optical lens assembly and the second optical lens assembly, and
a thickness profile of the first tunable optical lens assembly and a thickness profile of the second tunable optical lens assembly are modified independently from each other.

13. The image capture device of claim 12, further comprising:
a third optical lens assembly comprising one or more optical lenses, and
a third tunable optical lens assembly positioned between the third optical lens assembly and the image sensor, wherein
the first tunable optical lens assembly, the second tunable optical lens assembly, and the third tunable optical lens assembly modify a length of an optical path for optical zoom produced by the first optical lens assembly, the second optical lens assembly, and the third tunable optical lens assembly, and
thickness profiles of the first tunable optical lens assembly, the second tunable optical lens assembly, and the third tunable optical lens assembly are modified independently from each other.

14. The image capture device of claim 10, wherein the first tunable optical lens assembly comprises two thin film piezo actuators to adjust the thickness profile of the first tunable optical lens assembly to a tilted profile with a first distance between the first plate and the second plate at a first end portion of the tunable optical lens assembly being different from a second distance between the first plate and the second plate at a second end portion of the first tunable optical lens assembly.

15. The image capture device of claim 14, wherein the thickness profile of the first tunable optical lens assembly is adjusted in response to a detection of a change in a viewing direction of the image capture device.

16. A method comprising:
determining a thickness profile for a tunable optical lens, wherein the tunable optical lens comprises:
a first plate positioned on a first surface of the tunable optical lens that receives light;
a second plate positioned on a second surface of the tunable optical lens that emits the received light, wherein the first surface and the second surface are flat; and
at least one thin film piezo actuator to adjust the thickness profile of the tunable optical lens assembly; and
adjusting the thickness profile of the tunable optical lens assembly to the determined thickness profile by applying a control voltage to the at least one thin film piezo actuator.

17. The method of claim 16, wherein adjusting the thickness profile of the tunable optical lens assembly comprises:
maintaining a parallel position between the first plate and the second plate of the tunable optical lens assembly.

18. The method of claim 17, further comprising:
increasing or decreasing a distance between the first plate and the second plate of the tunable optical lens assembly for autofocus functionality.

19. The method of claim 16, wherein adjusting the thickness profile of the tunable optical lens assembly comprises:
adjusting the thickness profile of the tunable optical lens assembly to a tilted profile with a first distance between the first plate and the second plate at a first end portion of the tunable optical lens assembly being different from a second distance between the first plate and the second plate at a second end portion of the tunable optical lens assembly.

20. The method of claim 19, further comprising:
changing a direction of the received light in alignment with a central axis of a camera according to the tilted profile for optical image stabilization.
